(19) United States
(12) Patent Application Publication
(10) Pub. No.: US 2009/0076918 A1
(43) Pub. Date: Mar. 19, 2009

(54) Advertisement-Supported Shipping

(75) Inventor: Patrick Blanchet, Miami Beach, FL (US)

Correspondence Address: FOX ROTHSCHILD LLP;New York, 2000 Market Street, Tenth Floor, Philadelphia, PA, 19103, US

(73) Assignee: AdShip, LLC, Miami Beach, FL (US)

(21) Appl. No.: 12/233,029

(22) Filed: Sep. 18, 2008

Related U.S. Application Data
(60) Provisional application No. 60/973,384, filed on Sep. 18, 2007.

(51) Int. Cl. G06Q 30/00; G06Q 50/00; G06F 17/00

(52) U.S. Cl. 705/14; 705/408; 705/410

(57) ABSTRACT

A server accepts shipping information from would-be shippers, advertising information from would-be advertisers, and correlates the two to match up an advertiser with a suitable shipper. The server contacts a carrier with the shipping information to obtain a shipping label and tracking number, and forwards this to the shipper, together with the advertisement. The shipper places the advertisement within the package, and provides the package to the carrier for delivery. The server sends one or more tracking messages to the recipient, which contain tracking information and an advertisement. The advertiser pays an advertising fee, which is used to provide a reward to the shipper for carrying the advertisement.

### CROSS-REFERENCE TO RELATED APPLICATIONS

This application claims the benefit of U.S. Provisional Application 60/973,384 filed on Sep. 18, 2007, which is incorporated herein by reference.

### FIELD OF THE INVENTION

The present invention relates generally to advertising. More particularly, the present invention discloses a method and related system for connecting together advertisers with shippers to provide advertisement-supported shipping services.

### BACKGROUND OF THE INVENTION

Advertisement-supported shipping is an advertising and direct marketing method in which advertisements are included with a shipped package or envelope. In effect, advertisement-supported shipping turns shippers into publishers. An advertisement-supported shipping system, typically in the form of a server computer, is used to connect would-be advertisers with willing shippers. Known algorithms are used to optimally match an advertiser with a shipper based upon parameters provided by the two parties. These parameters may include, for example, the fee the advertiser is willing to pay, the destination address of the package, the content type of the package, the demographics of the intended recipient, and so forth. If a shipper compatible with an advertiser is found, and if the shipper is willing to accept the advertisement, the advertisement-supported shipping server forwards the advertisement to the shipper, who then prints it and affixes it to the package or envelope. The shipper then uses a carrier service, such as Federal Express, UPS, DHL, a governmental postal service or the like to ship the package with the affixed advertisement. The advertisement-supported shipping server accepts payment from the advertiser and provides a corresponding payment to the shipper. In the following, the term “package” is intended to be indicate boxes, cartons, envelopes and the like that a shipper may submit for delivery to a carrier.

Advertisement-supported shipping offers the ability to advertisers to target a very specific market whose audience, the intended recipient of the packages, is inherently interested in the medium (i.e., the package). However, a drawback is that not all carrier services permit a shipper to place an advertisement on the outside of a package, which is often provided for free by the carrier. Moreover, the recipient has only a single view of the advertisement. It would therefore be desirable to provide a advertisement-supported shipping method and system that may be employed with any carrier service and which further provides multiple views of the advertisement to the recipient.

### SUMMARY OF THE INVENTION

The present invention overcomes the drawbacks of the prior art. The present invention discloses a method and related system for providing advertisement-supported shipping services.

In one aspect, an advertisement-supported shipping method is disclosed, in which shipping information is accepted from at least a shipper wanting to ship a package, and advertising information is accepted from at least an advertiser. At least a portion of the shipping information is used to obtain a shipping label and a tracking number from a carrier. The shipping label and at least an advertisement, which is obtained from first advertising information obtained from a first advertiser, is provided to the shipper. Also, a first notification message is sent to a recipient of the package. The first notification message includes shipping status information for the package and an advertisement obtained from the first advertising information.

In preferred embodiments, the tracking number is subsequently used to obtain tracking information from the carrier, and a second notification message is then sent to the recipient that includes shipping status information obtained at least in part from the tracking information, and which further an advertisement obtained from the first advertising information.

In yet other preferred embodiments, the tracking number is used to obtain tracking information from the carrier, and a second notification message is sent to the recipient that includes shipping status information obtained at least in part from the tracking information, and that further includes an advertisement obtained from second advertising information of a second advertiser that is not the same as the first advertiser. Utilizing a second advertiser for the package may be performed as a result of, for example, the recipient clicking through on the first advertisement.

In various embodiments, in response to receiving a request from the recipient, a second notification message is sent to the recipient. The second notification message includes shipping status information and an advertisement obtained from the first advertising information. In yet other embodiments, the first and second notification messages are either a facsimile transmission, an email message, a web page, a cell phone message (SMS message), a message carried by an instant messaging service, and a telephonic message. In preferred embodiments, the second notification message is a web page and the first notification message is an email.

In certain embodiments, the shipper is instructed to print out the advertisement provided to the shipper and to place the advertisement inside the package.

In various other embodiments, demographic information contained in the shipping information and in the first advertising information is used to select the first advertising information from a plurality of advertising information records.

In yet other embodiments, a reward fee or a shipping rate discount is offered to the shipper, either of which is calculated from an advertising fee in the first advertising information. For example, the reward fee may equal the advertising fee, or be less than the advertising fee.

In yet another aspect, a system is provided for performing the above steps. The system includes at least one processor, memory in communications with the processor, communications hardware controllable by the processor for communicating with remote parties, and a database for storing information provided by the remote parties via the communications hardware. The memory includes program code executable by the processor to perform various embodiment method steps.

### BRIEF DESCRIPTION OF THE DRAWINGS

FIG. 1 is logical diagram of an embodiment advertisement-supported shipping services environment.

FIGS. 2A-2D are flow charts for an embodiment advertisement-supported shipping method.

FIG. 3 is a logical diagram of an embodiment user database.

FIG. 4 is a logical diagram of embodiment user interfaces.

FIG. 5 shows an embodiment user interface screen for obtaining certain portions of user personal data to create a user account.

FIG. 6 shows an embodiment user interface screen for obtaining other portions of user personal data to create a billing account.

FIG. 7 shows an embodiment user interface screen for permitting a shipper to select a multiple of shipping-related actions.

FIG. 8 shows an embodiment user interface screen for obtaining shipping information from a shipper.

FIG. 9 shows an embodiment user interface screen for permitting a shipper to select an advertisement that the shipper will carry.

FIG. 10 shows an embodiment user interface screen for permitting a shipper to confirm whether or not to proceed with shipping.

FIG. 11 shows an embodiment user interface screen for permitting a user to select from various advertising-related functions.

FIG. 12 shows an embodiment user interface screen for permitting a user to create or edit an advertising campaign.

FIG. 13 shows an embodiment user interface screen for permitting a user to select advertising data for an advertisement that may be associated with an advertising campaign.

FIG. 14 shows an embodiment user interface screen for permitting a user to select advertisements for a campaign, as well as indicate demographic information.

FIGS. 15A and 15B shows embodiment user interface screens for permitting a user to enter additional demographic information.

FIG. 16 shows an embodiment user interface screen for permitting a user to indicate advertising-related fees and a payment account.

FIG. 17 shows an embodiment user interface screen for permitting a user to modify aspects of an advertising campaign.

### DETAILED DESCRIPTION

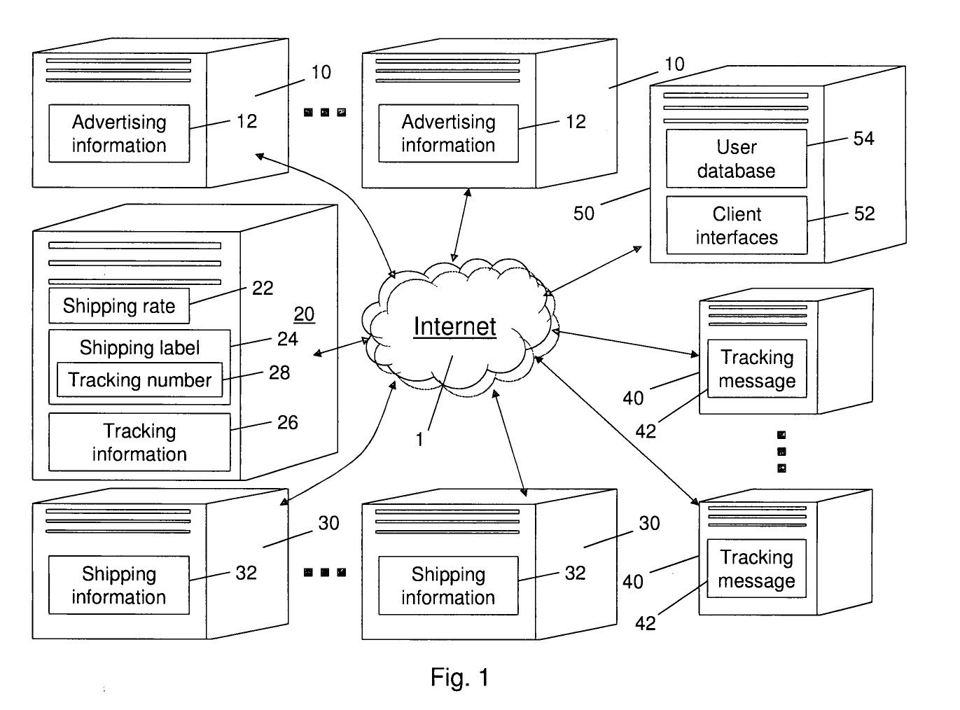

FIG. 1 is a logical diagram of a preferred embodiment advertisement-supported shipping services environment, which includes a plurality of advertisers 10, at least one carrier service 20, a plurality of shippers 30, a plurality of recipients 40, and an embodiment advertisement-supported shipping server 50. Each of the parties 10-40 is remote from the server 50, and typically from each other as well. These parties 10-50 are capable of communicating with each other through any one or more suitable communications mediums, preferably the Internet 1. It will be appreciated in the following that FIG. 1 simply depicts a preferred embodiment, and other logical arrangements are certainly possible. For example, the server 50 could directly interface with all of the other parties 10-40, rather than indirectly via the Internet 1, such as by way of telephone lines or the like. The ubiquity of the Internet 1, however, makes it a preferred communications medium. Combinations of the Internet 1 and, for example, telephone-based services may also be employed by the server 50.

In preferred embodiments the server 50 is a web server with client interfaces 52 capable of exchanging information with the other parties 10-40 over the Internet, and optionally over, for example, telephone lines. It will be appreciated that although logically the server 50 may appear as a single machine, in reality the server 50 may be provided by one or more computing systems, such as blade servers or the like, which are networked together using known network programming techniques to appear as a single machine to the other parties 10-40 accessible at a known URL. Similarly, if, for example, a telephone-based exchange of information is used, known PBX methods and devices may be used so that the telephone-based aspect of the server 50 appears at a single telephone number. The one or more computing platforms that provide the embodiment server 50 will include at least one processor connected to one or more communications devices and memory. The memory may be volatile, permanent or both, and the processor executes the program code stored in the memory to provide the functionality of the server 50, such as the client interfaces 52 and the updating of a database 54. The client interfaces 52 will control the one or more communications devices to provide for the exchange of information between the various parties 10-40 in accordance with the underlying communications hardware. For example, client interfaces may control standard networking hardware and corresponding protocols (such as Ethernet with TCP/IP), facsimile hardware, communications with an SMS gateway for a cell phone, a PBX for automated voice delivery services over phone lines, and the like. The program code causes the server 50 to perform the various embodiment server-side 50 method steps discussed below. In preferred embodiments, the program code is provided by way of web programming languages and interfaces, as known in the art, although any suitable language may be used. Providing such program code should be well within the means of one having ordinary skill in the art after having the benefits of the instant disclosure.

The memory of the server 50 includes a user database 54 that is used to store and process information received from the other parties 10-40. The database 54 may be a single file, or may be multiple files disposed on a single machine or across multiple machines. For example, using the client interfaces 52, the server 50 may communicate with one or more advertisers 10 to accept corresponding advertising information 12 from each advertiser 10. The advertising information 12 may include, for example, the name and contact information of the advertiser 10, the website address of the advertiser 10, billing information (such as credit card information or the like), and campaign information; this campaign information, in turn, may contain advertising information for each of a plurality of advertising campaigns, such as the URL of an advertisement or web page that the advertiser 10 desires a recipient 40 to see, a logo for the advertisement, text for the advertisement, desired demographics for the advertisement, a fee the advertiser 10 is willing to pay to place the advertisement, and so forth. Demographic information for the desired demographics may include, for example, a time frame for the advertisement, a target region (such as country, state, county, city, zip code, etc.), the goods or services being promoted, the income of the recipient, and any other information suitable for promoting goods and services. All of this information may be exchanged between the server 50 and the advertiser 10 via one or more suitable client interfaces 52, and then stored, for example, in corresponding fields and records within the user database 54. The client interface 52 may further permit the advertiser 10 to make changes to its corresponding advertising information 12 stored within the user database 54.

Similarly, using the client interfaces 52, the server 50 may accept shipping information 32 from one or more shippers/publishers 30 who may be willing to carry advertisements. The shipping information 32 may then be stored in the user database 54 for processing by the server 50. The shipping information 32 may include, for example, the contact information of the shipper 30, the carrier 20 to be used, account information with the carrier 20, billing information (such as credit card information), the destination address of a recipient 40 of the package, contact information for the recipient 40, the contents or content type of the package, information about the recipient 40, the size or type of the package, the package weight, and so forth. Contact information for the recipient 40 may include various fields, such as the email address of the recipient 40, the cell phone number of the recipient 40 for SMS services, a fax number of the recipient 40, and so forth. Using known correlating techniques, the server 50 may use the shipping information 32 and the advertising information 12 stored in the user database 54 to connect an advertiser 10 with a shipper 30. To this end, the server 50 may provide to the shipper 30 a predetermined number of advertisers 10 that most closely correlate with the shipper 30. The shipper 30 may then decide from this list which advertiser 10, if any, for whom it will carry an advertisement.

Typically, a shipper 30 is most interested in the amount of money that may be received for carrying an advertisement, and hence this may be an important correlating factor for shippers 30. Alternatively, advertisers 10 are generally more interested in the demographics of the package recipients 40, and hence this information may be an important correlating factor for advertisers 10. The server 50 may therefore use the shipping information 32 to determine which shippers 30 are sending packages to recipients 40 having demographics that are desired by the advertiser 10, such as locale of the recipient 40, package content types, related industries or services, or the like. Then, the server 50 may select the highest paying such advertisers 10 and present them to the shipper 30 for consideration. The shipper 30 may review the advertisements presented, and accept the one found most acceptable. In certain embodiments, the advertising information 12 may further include information about the type of advertisement to be carried, such as the brand name, the type of goods or services being promoted, or the target audience. In such embodiments, the shipping information 32 may further include data indicating the type of advertisements that the shipper 30 does not wish to carry, regardless of price, and the server 50 may then further “weed out” potential advertisers based on this information before presenting to the shipper 30 the potential advertisers 10. In preferred embodiments, to assist the shipper 30 in its reviewing process, the client interface 52 permits the shipper 30 to see a copy of the advertisement that the advertiser 10 is asking the shipper 30 to carry.

Once a shipper 30 agrees to carry an advertisement for an advertiser 10, the server 50 contacts the carrier 20 and, using the shipping information 32, obtains a shipping rate 22 from the carrier 20. As indicated, the shipping information 32 may include the carrier 20 to use, such as Federal Express, DHL or the like, as well as the package weight and size. The server 50 includes a suitable client interface 52 for each supported carrier 20 to obtain information from the carrier 20, using, for example, Web Services or an API provided by the carrier 20, and provides the information required by the carrier 20 to obtain the shipping rate quote 22. The server 50 then forwards the rate information 22 to the shipper 30, as well as information indicating how much the shipper 30 will receive as a reward fee for carrying the advertisement of the advertiser 10. Note that this reward fee need not necessarily be equal to the advertising fee that the advertiser 10 is willing to pay.

In preferred embodiments, the server 50 provides to the shipper 30 various options for proceeding with the shipment. For example, the shipper 30 may entirely decline to ship the package and so indicate to the server 50. Or, the shipper 30 may request to change or edit certain shipping parameters, such as the particular delivery options offered by the carrier 20, the carrier 20 itself, or details about the package weight, size or both; the server 50 may then again contact the carrier 20, or a new carrier 20, with this new shipping information 32 to provide an updated shipping rate 22 to the shipper 30.

If the shipper 30 decides to ship the package in accordance with the shipping rate 22, the server 50 may offer one or more different options for crediting to the shipper 30 the reward fee. For example, using the shipper's 30 account information, such as the shipper's 30 credit card, the server 50 may charge to the shipper 30 the shipping rate 22 of the package reduced by an amount equal to the reward fee. The server 50 would thus pay the carrier 20 the full shipping rate 22, for example by using an account that the server 50 has with the carrier 20, but only charge to the shipper 30 a shipping fee that has been reduced, perhaps significantly, by the reward fee. From the point of view of the shipper 30, then, it would appear as though a much cheaper shipping rate 22 was charged to the shipper's 30 account, such as the shipper's 30 credit card.

Alternatively, the server 50 may provide to the carrier 20 the account information of the shipper 30, such as the shipper's 30 credit card information or carrier 20 account details, but credit to an account held within the user database 54 an amount equal to the reward fee. From the point of view of the shipper 30, the shipper 30 would see that the full shipping rate 22 was charged to, for example, the shipper's 30 credit card or carrier 20 account, but would also be able to see that an account the shipper 30 has with the server 50 has a balance that has increased by the reward fee.

With regards to this account held in the user database 54 for the benefit of the shipper 30, the server 50 may provide various options to the shipper 30 to enjoy the credit within the account. For example, the server 50 may provide the option to credit to another account any balance present in the shipper's 30 user database 54 account. The shipper 30 may then, for example, request a balance transfer to credit another account of the shipper 30, such as a credit card, a bank account, a PayPal account or the like. Or, for example, the shipper 30 may use the account to enjoy reduced shipping rates at another time for a different package.

Once the shipper 30 agrees to ship the package, the server 50 requests a shipping label 24 from the carrier 20, using the appropriate shipping information 32 provided by the shipper 30. The server 50 may optionally contact the carrier 20 to confirm that the shipping information 510 is valid. Once the destination address of the package is confirmed, the server 50 may charge to the account of the advertiser 10 the advertising fee. Depending upon how the shipper 30 wishes to process the transaction, as discussed above, the server 50 may provide the shipper's 30 account information to the carrier 20 (such as an account the shipper 30 has with the carrier 20, or credit card information of the shipper 30), or may pay the shipping rate 22 itself. The shipping label 24 will typically include a tracking number 28. Alternatively, the server 50 may learn of the tracking number 28 through other appropriate interfacing means via the carrier interface 540. It will be appreciated that the tracking number 28 may, in fact, be a combination of numbers and letters. The server 50 records this tracking number 28 in the user database 54, for example as part of the shipping information 32. The server 50 then sends to the shipper 30 the shipping label 24 as well as a copy of an advertisement as provided by the advertising information 12. For example, both the shipping label 24 and the advertisement could be provided to the shipper 30 in a PDF document, a JPEG document or the like. In preferred embodiments, the advertisement and the shipping label 24 are presented in respective web page screens, which may then be printed by the shipper 30. The user interface 550 may employ any suitable means, however, for providing the advertisement and the shipping label 24 to the shipper 30.

Once the shipper 30 receives the shipping label 24 and the advertisement, the shipper 30 prints both of these out. The shipper attaches the shipping label 24 to the outside of the package in accordance with the shipping policies of the carrier 20. The shipper 30 also includes inside the package the printout of the advertisement. The shipper 30 then provides to the carrier 20 the package, which the carrier 20 then delivers to the recipient 40.

As previously indicated, the contact information of the recipient 40, such as the email address of the recipient 40, may be included as part of the shipping information 32. The shipper 30 may receive this contact information from the recipient 40, and then provide it to the server 50, which then saves this contact information within the user database 54. Hence, once the shipper 30 has agreed to ship the package and the server 50 has provided the advertisement and shipping label 24 to the shipper 30, the server 50 further sends a notification message 42 to the intended recipient 40 indicating that the package is being shipped and providing tracking details. Hence, the notification message 42 contains shipping status information for the recipient 40, and an advertisement. The type of notification provided may depend upon the type of contact information provided. For example, the notification 42 may be in the form of an email message, an SMS message to a cell phone, a fax, or any other suitable communications medium controllable by the server 50. Hence, the recipient interface 560 used may depend upon the contact information provided. Exemplary recipient interfaces 560 include SMTP, FTP, HTTP, instant messaging protocols, facsimile protocols, SMS protocols (which typically interface with an SMS gateway, as known in the art), VXML, and so forth. Any suitable recipient interface 560 technology may be employed to contact the recipient 40, and providing such recipient interfaces 40 are routine for those of ordinary skill in the art.

This notification message 42 may include the advertiser's 10 advertisement, or an advertisement derived from materials provided in the advertising information 12, such as a logo, text, a hyperlink, a clickable banner, a short video, an image or combinations thereof. The tracking details may include the tracking number 28 for the package as provided by the carrier 20, and the current shipping status of the package, such as waiting for pick-up, in-transit, delayed, transit information and so forth, and may further include, for example, a hyperlink to the server 50. When the user clicks upon this hyperlink, using an appropriate client interface 52 (such as an HTTP server 560) the server 50 may contact the carrier 20, obtain the most recent tracking information 26 for the package, and forward this tracking information 26 back to the recipient 40, together with the advertisement, via a web page 42. Hence, this web page 42 delivered to the recipient 40 may contain, for example, the most recent carrier 20 shipping status tracking information 26; the logo, text, image, clickable banner, video, or combinations thereof of the advertisement provided by the advertiser 10 within the advertising information 12; and, optionally, a hyperlink associated with the advertisement as provided by the advertising information 12. The particular formatting of such a web page 42 is a matter of design choice, as well as what type of information to include. Additionally, periodically, such as daily or even more frequently, the server 50 may check the user database 54 for any packages that have not yet been indicated by the carrier 20 as delivered. For each of these packages, using the associated tracking number 28 within the shipping information 32 and appropriate carrier interface 540, the server 50 may contact the associated carrier 20, provide a package tracking number 28 and obtain the most recent shipping status tracking information 26 for that package. This shipping status tracking information 26 may then be provided in a notification message 42 to the recipient 40, together with the advertisement, using an appropriate recipient interface 560, such as SMTP for an email message 42. In preferred embodiments, the server 50 only contacts the recipient 40 if a delivery status change has occurred with the package, such as in-route information, delay information, or delivery confirmation information that has been added since the last status check for the package. Hence, the most recent tracking information 26 may further be stored in the user database 54 as part of the shipping information 32, for example, for that package. The results of the most recent tracking information 26 obtained from the carrier 20 may be compared to the results stored in the database 54 to determine if a notification message 42 should be sent to the recipient 40, and the database 54 may be updated accordingly. In preferred embodiments, notification messages are 42 sent when first the package is shipped, again when the package is delivered, and yet again if the package is delayed in transit.

As a result of the notification messages 42 to the recipient 40, the recipient 40 will receive multiple views of the advertisement, such as the hard copy of the advertisement present within the package itself, the initial delivery notification 42 from the server 50; a delivery confirmation message 42 from the server 50, and any in-route status change notification messages 42, such as shipment delay notifications or the like. Further, as each of these notification messages 42 may contain a hyperlink that the recipient 40 can click upon to get the most recent shipping status tracking information 26 from the carrier 20 via the server 50, and as each click on such hyperlinks will generate a web page 42 that includes not only the tracking information 26 but also another copy of the advertisement, it is possible that the recipient 40 will have many impressions of the advertisement. Moreover, if the advertiser 10 is satisfied with, for example, the first click-though of the recipient 40 when receiving the notification message 42, then the server 50 may subsequently include a different advertisement in notification messages 42 for the same package. Hence, subsequent advertisements within notification messages 42 for the same package may employ different advertising information 520.

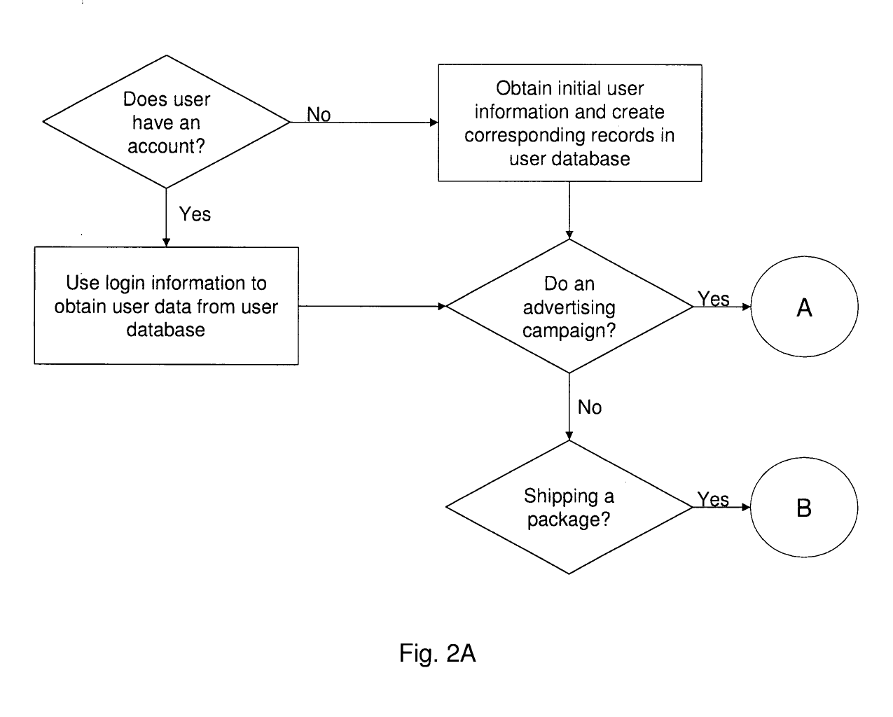

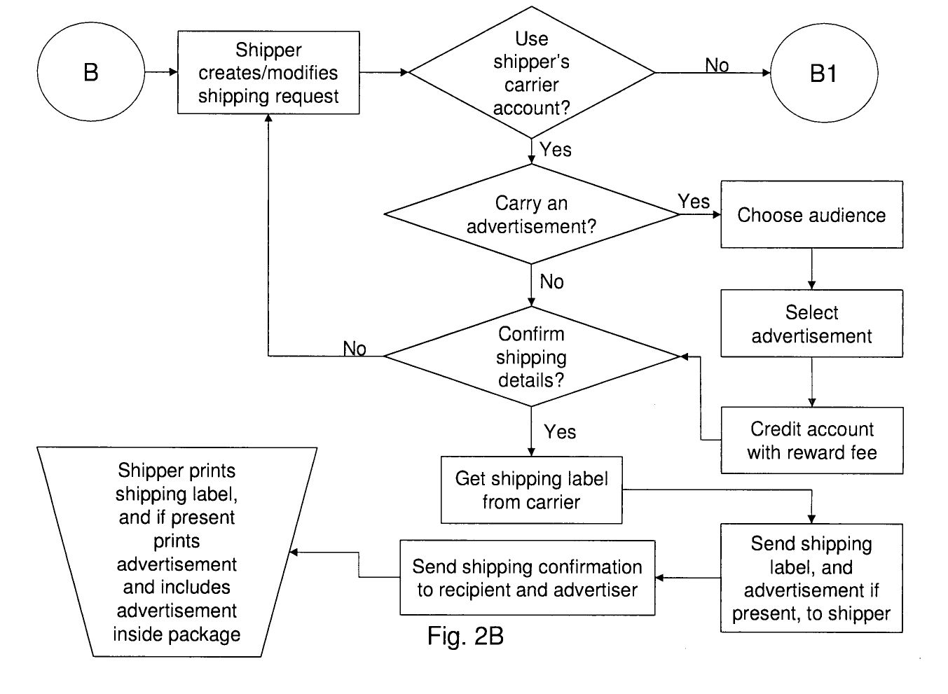

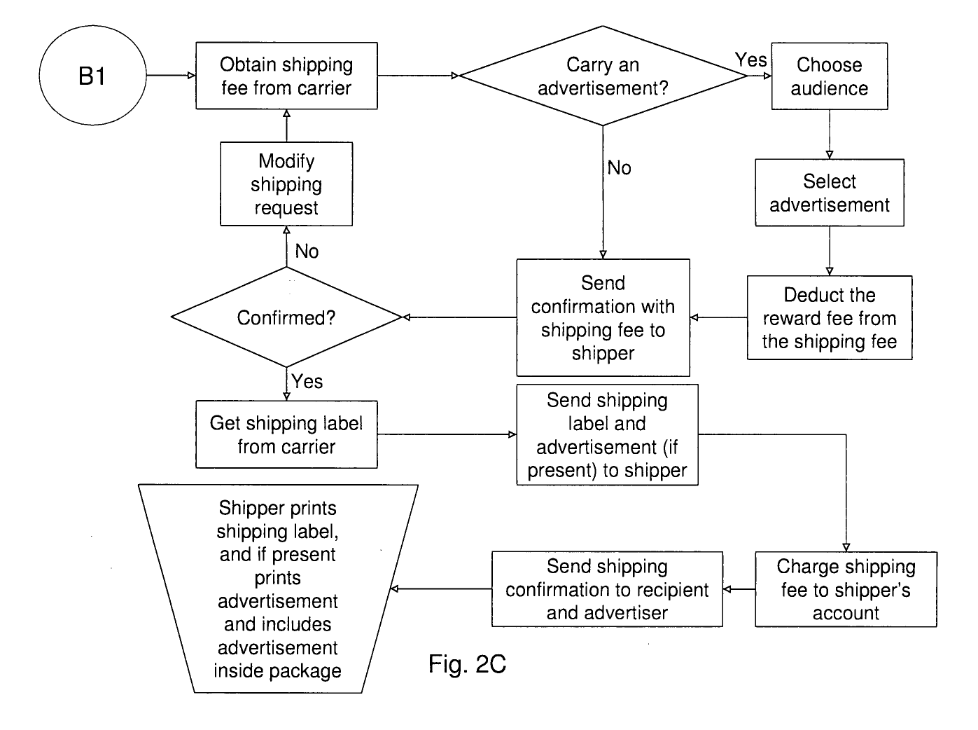

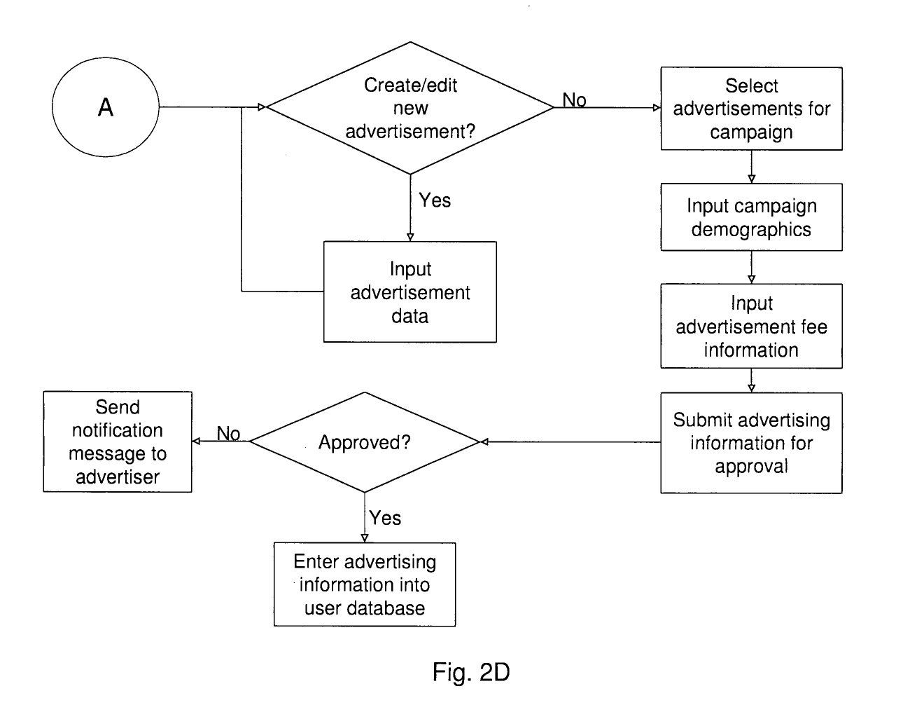

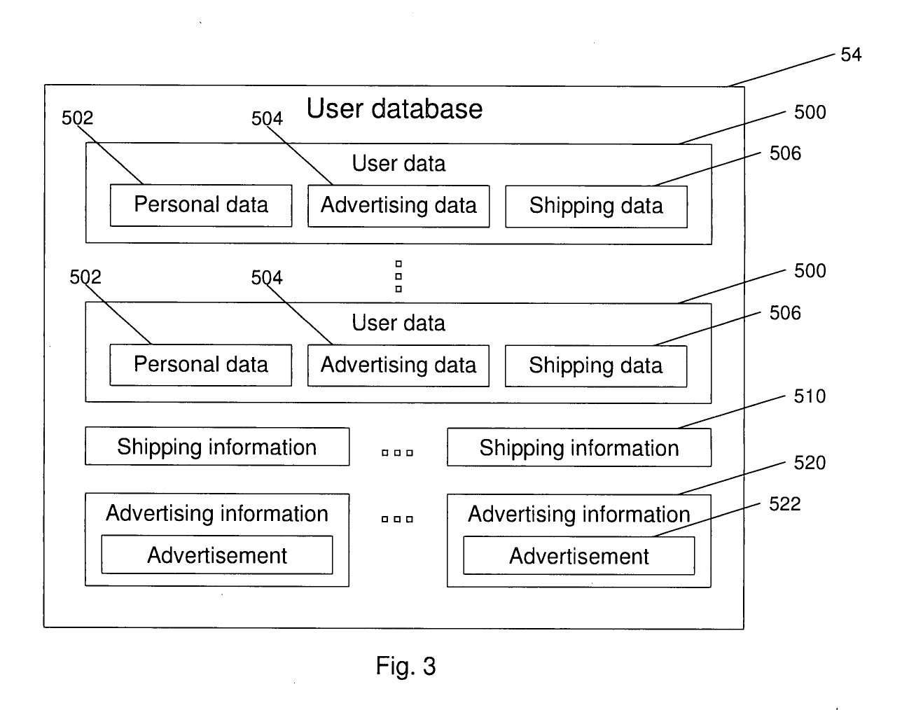

FIG. 2A provides a flow chart for an embodiment server 50. As an initial step, a user, which may be, for example, a shipper 30, an advertiser 10 or both, may either log into, or create an account with, the server 50 to provide association of that user 10, 30 with the user database 54. With further reference to FIG. 3, an embodiment user database 54 may be, for example, a relational database as known in the art, although any type of database capable of holding the information needed to effect an embodiment method may be employed. The user database 54 may contain, for example, a plurality of user data records 500 corresponding to users 10, 30 of the system 50. The database 54 may also include a plurality of shipping information records 510 used to store corresponding shipping information 32, and a plurality of advertising information records 520 used to store corresponding advertising information 12. Each of these records 500, 510, 520, may itself contain a plurality of fields or sub-records.

For example, each user data record 500 may include a personal data sub-record 502, which may hold, for example, the name, physical address, email address, fax number, cell phone number, instant messaging address, any other contact information, login name, login password, credit card information, reward fee account balance, and combinations thereof for that user 10, 30. Each user data record 500 may also include an advertising data sub-record 504 for referencing advertising information 520 associated with that user 10; similarly, the user data record 500 may include a shipping data sub-record 506 that references shipping information 510 for that user 30.

Each shipping information record 510 may include various sub-records or fields, such as the name, physical address and zip code of the recipient 40, email address, cell phone number, fax number, instant messaging address, any other contact information, demographics and combinations thereof of the recipient 40; the tracking history of the package as obtained from the shipping status tracking information 26 from the carrier 20; the tracking number 28 of the package; the size and weight of the package; the content type of the package; industries or interest groups associated with the package; the name and address of the sender, and so forth.

Each advertising information record 520 may include or reference, for example, an advertising hyperlink that a recipient 40 may click to obtain additional information about a product or service, an advertising logo, advertising text, an advertising video, a banner, an image, the advertising fee, the target demographics (such as location, product type, etc.), the type of goods or services being promoted, one or more full pages of advertising copy, and so forth. In preferred embodiments, each advertising information record 520 may store references to one or more advertisements 522, and each advertisement 522, in turn, stores or references an advertising hyperlink, logo, text, video, banner, image, advertising copy, etc. Additionally, in such preferred embodiments, each advertising information record 520 stores the target demographic information and advertising fee information. Hence, a single advertising information record 520 may be used to support multiple advertisements 522.

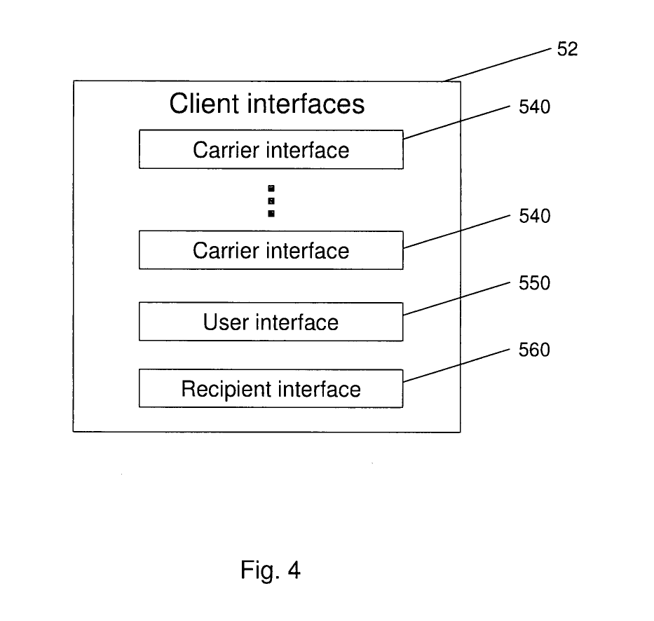

With further reference to FIG. 4, the client interfaces 52 may include one or more carrier interfaces 540, each for interfacing with a respective carrier 20 to obtain the shipping rate 22, shipping label 24, tracking information 26, and tracking number 28 of a package from that carrier 20. Such interfaces 540 are known in the art, support for which are typically provided by the carriers 20, via, for example, Web Services or APIs. Hence, providing the carrier interfaces 540 is a routine skill for those of reasonable skill in the art. The client interfaces 52 further include a user interface 550 that is used to obtain information from, and provide information to, advertisers 10 and shippers 30. Any suitable interface may be used for the user interface 550, such as an HTTP interface. There is also a recipient interface 560, which is used to provide information to a recipient 40; typically, this may be both via email (i.e., SMTP) and by serving a webpage (i.e., HTTP), as described above, to provide notification messages 42 to the recipient 40 that includes an advertisement with the tracking data 42. However, as discussed above, the recipient interfaces 560 may further include support for SMS, facsimiles, Voice XML (VXML), instant messaging and any other suitable communications medium.

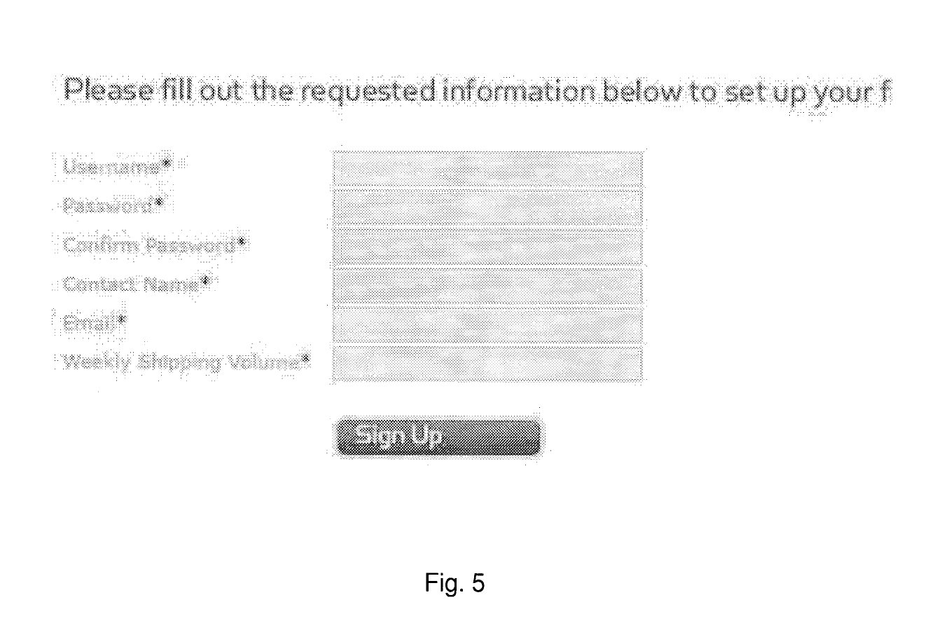

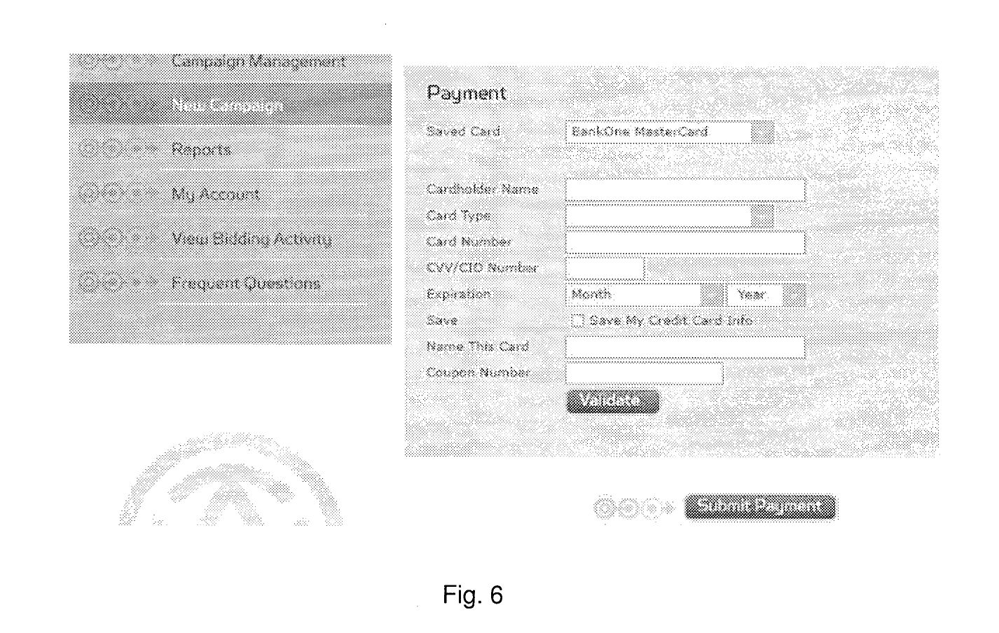

As shown with further reference to FIG. 5, if the user 10, 30 does not currently have an account with the server 50, the user interface 550 may present a webpage that permits a user 10, 30 to enter personal data, such as the user's name, login name, password and email address. This information is then used to create a new user data record 500 in the user database 54 with the personal data sub-record 502 filled in accordingly. As shown in FIG. 6, the user interface 550 may also present a webpage that permits the user 500 to enter charge account information, such as credit card information, as well as account information that the user may have with a carrier 20, all of which may then also be placed within the personal data sub-record 502 of that user's user data record 500. Preferably, all account information is encrypted within the database 54 using any suitable technique. Alternatively, if the user 10, 30 already has an account, any suitable login procedure may be supported by the user interface 500 to identify the user 10, 30 and thus find within the database 54 the corresponding user data record 500. Subsequently, the user interface 500 may present a webpage that permits the user 10, 30 to, for example, perform or modify an advertising campaign, or to ship a package.

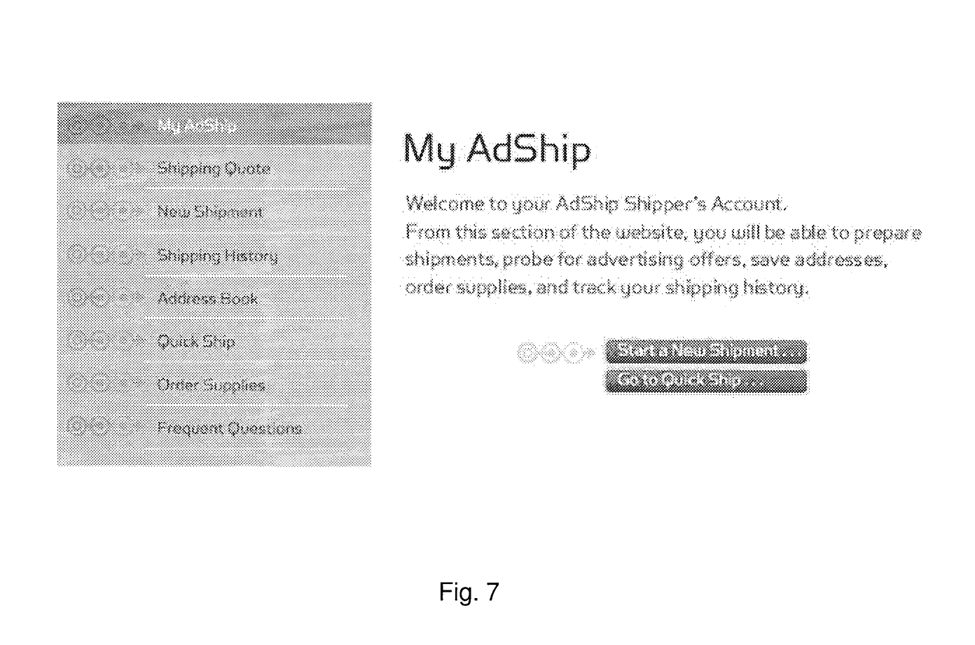

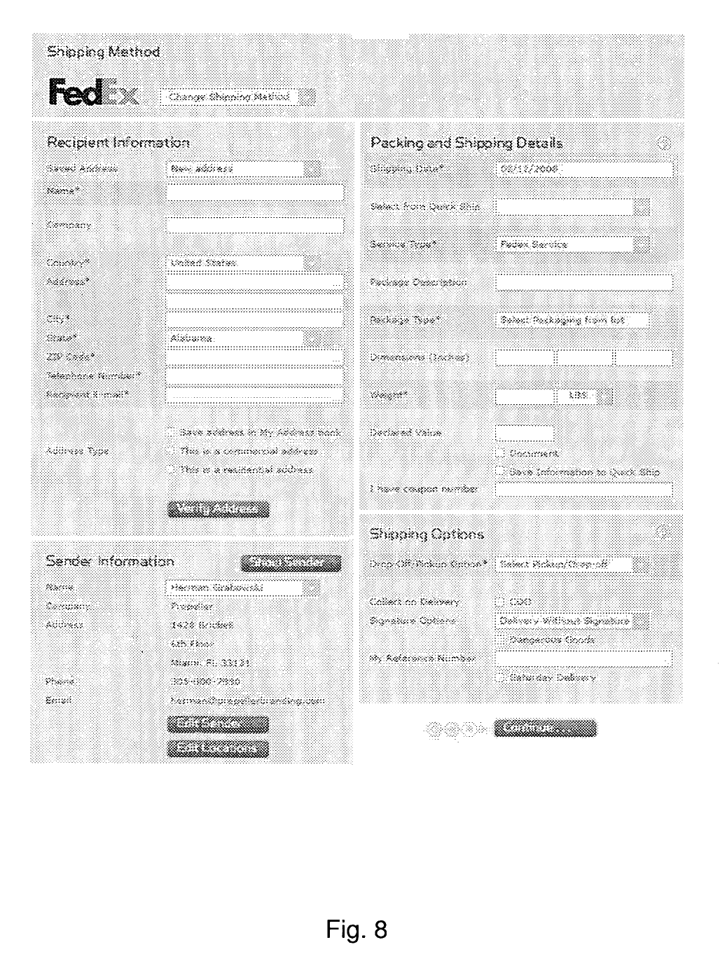

As shown by FIG. 7, if the user 30 indicates that shipping-related services are desired, the user interface 550 may present a webpage that permits the user 30 to select from a plurality of options, such as obtaining a shipping quote, viewing that user's shipping history, managing an address book, or making a new shipment. With further reference to FIG. 2B and FIG. 8, if the user 30 indicates that a new shipment is desired, then the user interface 550 may present a shipping information webpage that permits the user 30 to enter or modify shipping information 32 for this new shipment, which may be subsequently used to create a new shipping information record 510 that is referenced within the shipping data record 506 of the user record 500. The shipping information webpage may collect all relevant shipping information 32 from the shipper 30, such as one or more of: the recipient's 40 name, physical address, email address, telephone number, cell phone number, fax number, instant messaging account information, and other recipient-centric demographic information; information about the sender; information about the package, such as weight and size; information about the package contents, such as types and value, related service or industries, and any other types of package-centric demographic information; the carrier 20 to use; shipping options for that carrier 20, such as overnight, standard, three-day, COD, where to drop-off or pick-up, whether a recipient 40 signature is needed, the shipper's reference number, etc.; the name and address of the sender, and the shipping date. All of this information, and any other shipping-relevant information, may be finally placed into corresponding fields within the shipping information record 510 for the package. It is a benefit of the server 50 that it may support a plurality of carriers 20, and hence a user 30 may have a single account on the server 50 that stores that user's address book, shipping history, and so forth, which can be of great convenience to the user 30 as this single server 50 may track packages and their related histories from a plurality of carriers 20.

The user interface 550 may further request from the shipper 30 whether the shipper 30 wishes to use an account with the selected carrier 20 that the shipper 30 may have to pay the carrier 20 shipping fees. If the shipper 30 elects to use his or her own account with the carrier 20, then the server 50 presents information about the shipment to the shipper 30, such as the address of the recipient 40, the shipping fees, the type of delivery and so forth. If the shipper 30 does not agree to the shipping information, the server 50 may then permit the shipper to abandon the shipment, or to modify the shipping information 32, and thus the shipping information 510 for the package, and repeat the process. However, if the shipper 30 agrees to the shipping details, then the server 50 uses the account information for the carrier 20 stored in the personal data sub-record 502, as well as the shipping information 510, to obtain an appropriate shipping label 24 from the carrier 20 for the package, using the corresponding carrier interface 540 for the carrier 20. The shipping label 24, and its associated tracking number 28, are then stored in the shipping information 510 for the package. The user interface 550 may then permit the shipper 30 to choose whether or not to carry an advertisement. If no advertisement is desired, then the server 50 simply sends the shipping label 24 to the shipper 30; in some embodiments, this shipping label may be modified slightly from the original to carry, for example, a small logo or advertisement on the label 24 itself, such as a logo identifying the advertising server 50. Once in receipt of the label 24, the shipper 30 prints out the label 24, affixes it to the package and provides the package to the carrier 20 for delivery to the recipient 40. The server 50 also, using the recipient interface 560, sends a notification, such as an email, to the recipient 40 that the package is being delivered, as previously discussed. Simply by way of example, the label 24 may appear on the screen of the shipper's 30 computer, from which the shipper 30 may print the label 24.

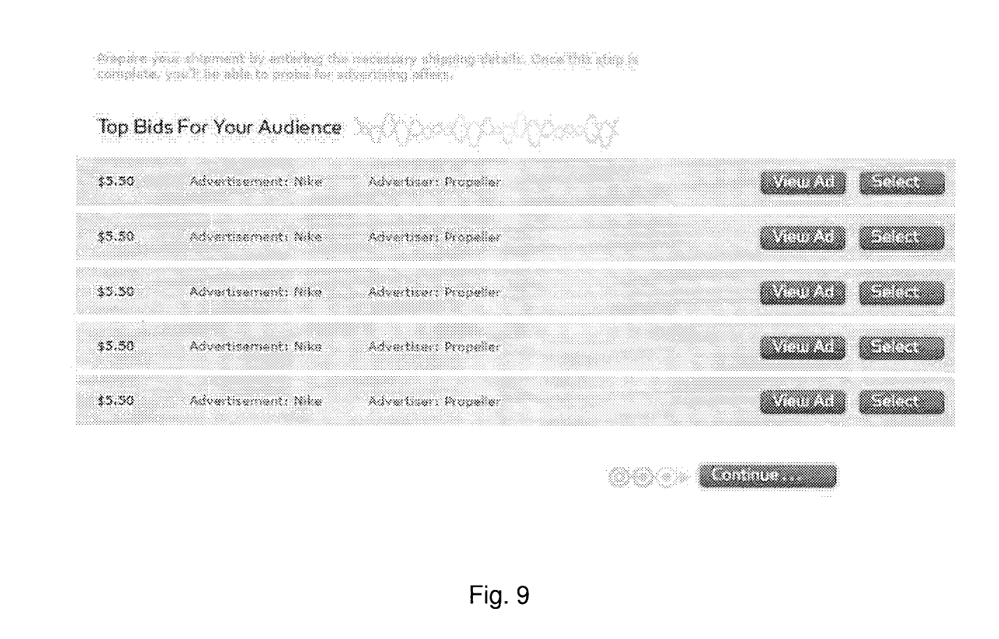

Continuing with the remainder of FIG. 2B, if in the alternative the shipper 30 chooses to carry an advertisement, then the server 50 employs the shipping information 510 for the package to find the closest correlations with the advertising information 520 to choose an advertising audience. Any suitable technique may be performed to perform this correlating step. Simply by way of example, the server 50 may correlate packages with advertisements based upon the region to which the package is being shipped and the target region of the advertisement; or upon the contents carried by the package and the types of goods or services being promoted by the advertisement. The server 50 may then select, for example, one or more, such as the top five, of the highest bidding advertisers 10 that satisfy the correlation requirements and present these advertisers 10 in an ordered list to the shipper 30, as shown in FIG. 9. This list may permit, for example, the shipper 30 to view the advertisement of the corresponding advertiser 10, and to select a specific advertiser 10 for whom the shipper 30 will carry an advertisement. By permitting the shipper 30 to view the advertisements before agreeing to carry them, the shipper 30 may vet the advertisements for goods, services or content that the shipper 30 finds, for example, objectionable.

Once the shipper 30 agrees to accept an advertisement, a reference to the advertising information 520 for that advertisement may be placed within a field in the shipping information 510 for the package, thereby associating the package with the advertisement that the package will carry. A reference to the advertising information 520 may also be placed within the shipping information 510 for that package. The reward account of the shipper 30, as stored, for example, in the shipper's 30 personal data sub-record 502, is then credited with the reward fee as held in the advertising information 520, or as computed from the advertising fee held in the advertising information 520. Similarly, using the billing account information held in the personal data sub-record 502 of the advertiser 10, the billing account of the advertiser 10 is debited by the advertising fee as held in the advertising information 520. As noted previously, the credit to the shipper's 30 rewards account need not equal the debit placed against the advertiser's 10 billing account.

Using the shipping information 510 and the advertising information 520, the server 50 sends the shipping label 24 and an advertisement 522 to the shipper 30. Using the recipient interface 560, the server 50 also sends a shipping notification message 42 to the recipient 40 of the package, which will also include an advertisement 522. Also, so that the advertiser 10 may track the results of the advertising campaign 520, the server 50 further sends a notification message to the advertiser 10 indicating that a package with an advertisement 522 is being shipped; any suitable information may be included in this notification message to the advertiser 10. Typically, this notification message to the advertiser 10 may include all of the information that is sent to the recipient 40, including a tracking number. However, in preferred embodiments, the tracking number sent to the advertiser 10 is a coded tracking number that is different from the shipper tracking number 28. Hence, to use this coded tracking number to track the package, the advertiser 10 preferably interfaces through the server 50. The server 50 may use the coded tracking number to look up the actual tracking number 28 to obtain the most recent tracking information 26 from the carrier 20 to update the shipping information 510, and then selectively determine what shipping information 510 to provide to the advertiser 10 to track progress of the package. In this manner, the server 50 may enforce privacy issue with all users 10-40 of the system 50. Each advertisement 522 may therefore be fully trackable for both the shipper 30 and advertiser 10.

The advertisement provided to the shipper 30 for printing need not be the same as that provided in the notification message 42 sent to the recipient 40, although in preferred embodiments they are the same. In some embodiments, as discussed earlier, the advertisements in the notification messages 42 may change if the recipient 40 clicks though an earlier notification message 42, and thus advertisements 522 of an entirely different advertising campaign 520 and advertiser 10 may be sent to the recipient 40. By way of example, the recipient 40 may receive an email 42 that contains the tracking number of the package, an advertising hyperlink, a tracking hyperlink that connects to the server 50, an advertising logo, and related advertising text, which may be formatted based on certain design choices. On the other hand, the advertisement sent to the shipper 30 could be, for example, an image of a full page advertisement. The information for each type of advertisement 522 may be held in the advertising information record 520 for that advertisement, as provided by the advertiser 10 through, for example, suitable user interfaces 550, as discussed below.

With reference to FIG. 2C, once a shipper 30 has entered in the shipping information 510 for a package, and if the shipper 30 does not wish to use an account with the carrier 20, then the server 50 utilizes an appropriate carrier interface 540 to contact the carrier 20 and, using the shipping information 510, obtains a shipping rate 22 from the carrier 20. The shipper 30 may decide whether or not to carry an advertisement. If the shipper 30 decides not to carry an advertisement, then the server 50 presents to the shipper 30 the shipping fee 22 as obtained from the carrier 20, the various shipping details, such as the recipient's 40 name, physical address and contact information, and then requests the shipper 30 to confirm the shipment. If the shipment is not confirmed, the server 50 may permit the shipper 30 to modify the shipping information 510 for the package, and then may use the new shipping information 510 to obtain a new shipping rate 22 from the carrier 20.

On the other hand, if the shipper 30 confirms the shipment, then the server 50 obtains the shipping label 24 from the carrier 20. The server 50 may use an account, for example, that the server 50 has with the carrier 20 to pay the shipping fees 22. The server 50 stores the shipping label 24 and related tracking number 28 in the shipping information 510 for the package, and then provides the shipping label 24 to the shipper 30. As noted earlier, the label 24 provided to the shipper 30 may be slightly modified from the original. The server 50 also uses the shipper's 30 account information, such as the shipper's 30 credit card information, stored in the personal data sub-record 502 to charge the shipping fee 22 to the shipper 30. Note that the sequence of events may, of course, be altered. For example, the shipper's 30 account may be verified and charged first, and only then may the server 50 contact the carrier 20 to obtain the shipping label 24. The server 50 also uses the recipient interface 560 to send a shipment notification message 42 to the recipient 40. The shipper 30 then prints the shipping label 24 received from the server 50, affixes it to the package, and provides the package to the carrier 20 for delivery.

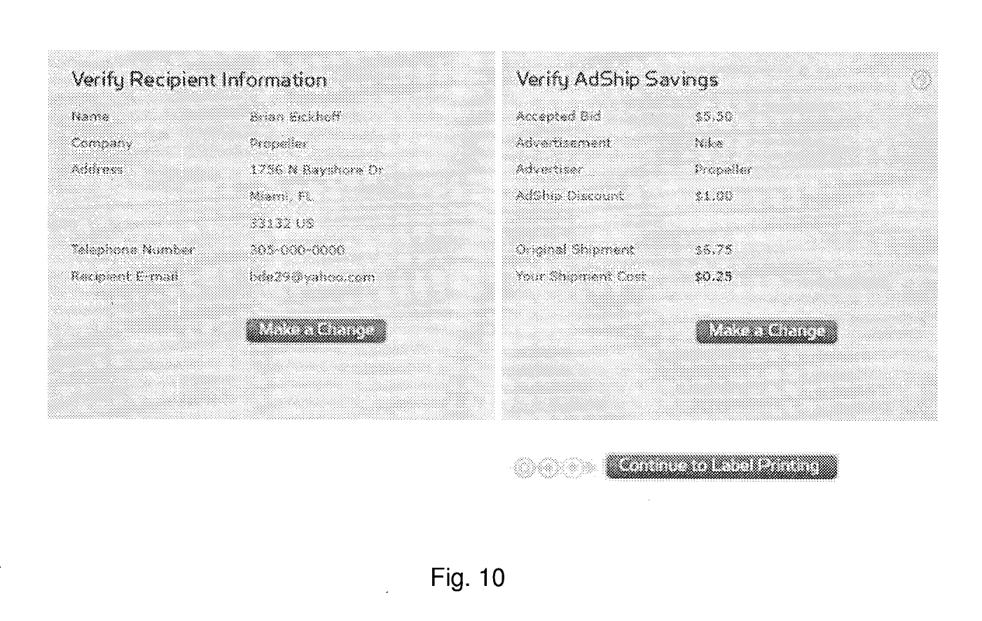

Alternatively, if the shipper 30 decides to carry an advertisement, then the server 50 may generate a list of suitable advertisers 10 and permit the shipper 30 to selected a specific advertisement, as described earlier. A reference to the advertising information 520 for the selected advertisement is then placed in the shipping information 510 for the package. The server 50 may then reduce the shipping rate 22 by an amount that is at least equal to the reward fee as obtained from the advertising information 520 to generate a discounted shipping fee. During the confirmation step, as shown in FIG. 10, the server 50 may provide various details to the shipper 30, such as information related to the recipient 40, the reward fee for carrying the advertisement, the name of the advertiser 10, the type of advertisement, the original shipping fee 22 as provided by the carrier 20, any discounts that the server 50 may enjoy with the carrier 20 and that can be passed along in whole or in part to the shipper 30, and the actual shipping fee that will be charged to the shipper 30. The shipper 30 may elect to make modifications to any of the above, in which case the process may repeat.

Once the shipper 30 confirms the shipment, the steps proceed much as they were described above with reference to when no advertisement is carried. However, the server 50 sends to the shipper 30 not only the shipping label 24, but also sends the related advertisement 522 as obtained from the advertising information 520. The server 50 may also provide instructions to the shipper 30 as to what to do with the provided shipping label 24 and advertisement, or such instructions may be accessible to the shipper 30 on the server 50, such as through a “Help” webpage. In accordance with such instructions, the shipper 30 prints out the label 24 as received from the server 50 and affixes it to the package in a standard manner. The shipper 30 also prints out the advertisement provided by the server 50 and places it inside the package. The server 50 also sends a shipping notification message 42 to the recipient 40 which contains for example, tracking information, a link to the server 50 for further package tracking purposes, and an advertisement 522, which may be an advertising hyperlink, an advertising logo, advertising text, a video, a clickable banner and so forth, or combinations thereof, as obtained from the advertising information 520. The server 50 also sends a notification message to the advertiser 10 indicating that an advertisement 522 is being shipped with a package, and providing any relevant details, as discussed earlier.

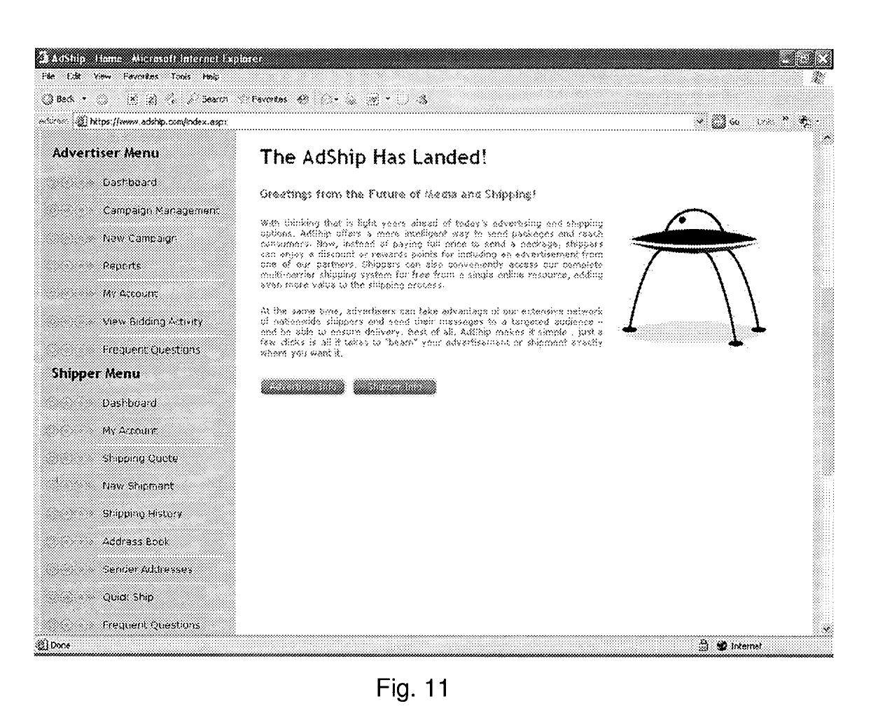

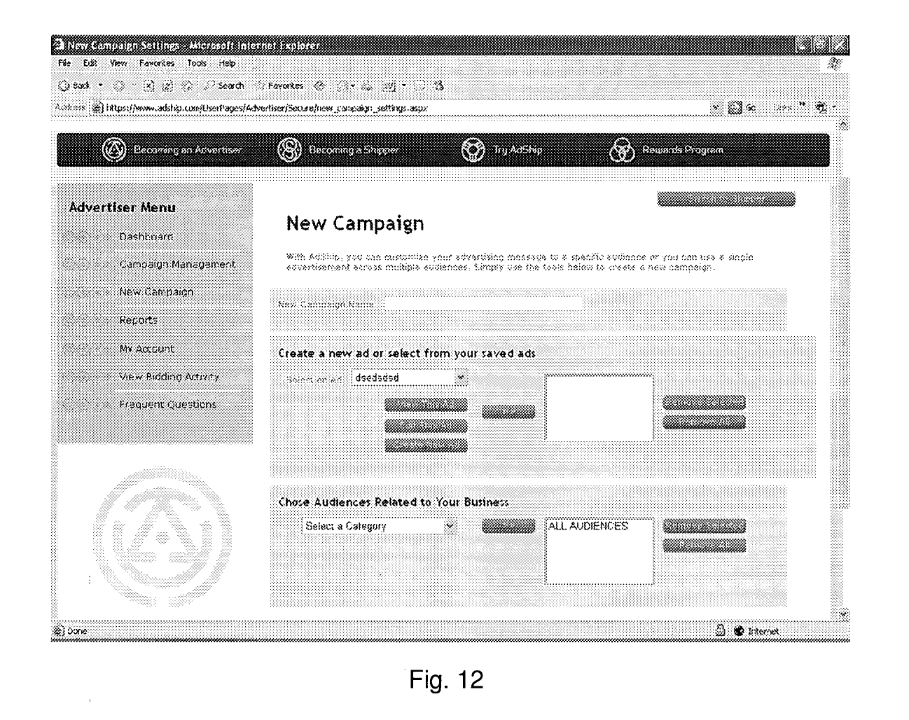

As shown by FIG. 11, the user interface 540 may present to the user 10, 30 advertising-related services. For example, the user 10 may create a new advertising campaign, may obtain reports about past or pending advertising campaigns, and may edit pending advertising campaigns. With further reference to FIG. 2D, if the advertiser 10 decides to start a new advertising campaign, the user interface 550 permits the advertiser 10 to provide various details about the campaign, which will be subsequently used as related advertising information 520. This information may include, for example, the name of the campaign, and the advertisements 522 to use in the campaign. An advertising campaign may include one or more advertisements 522. Each advertisement 522, in turn, may have its own related set of advertising text, logos, banners, videos, and so forth. Each advertisement 522 may be stored in the user database 54 as a distinct record that may be referenced within the advertising information 520. As shown in FIG. 12, the user interface 550 permits the advertiser 10 to select individual advertisements 522 that will be used in the new advertising campaign. The advertiser 10 may further view and edit these advertisements 522 before selecting them for use in an advertising campaign.

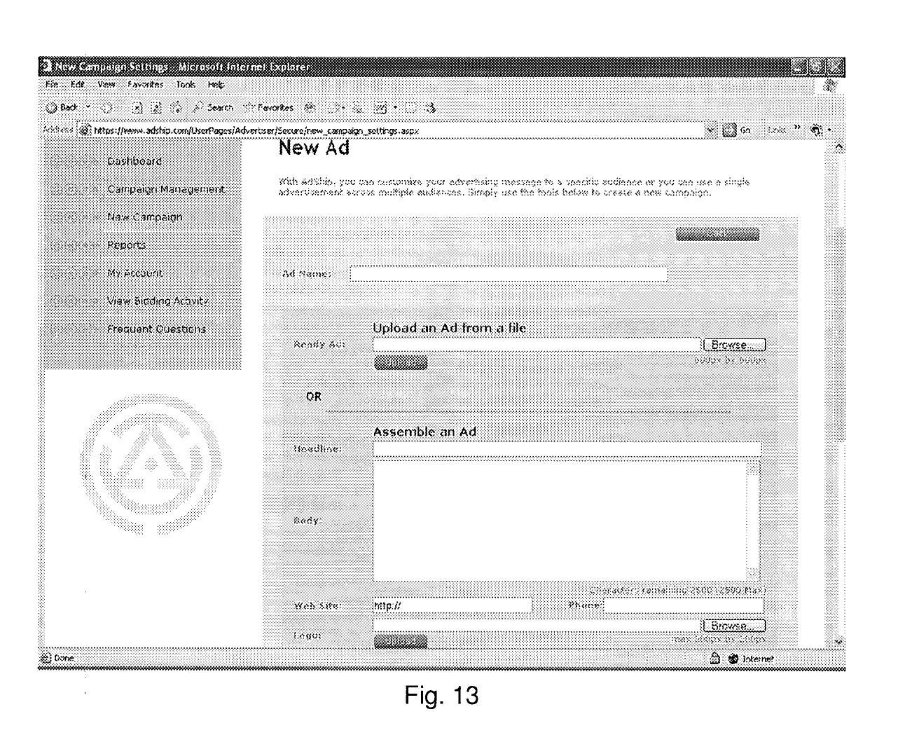

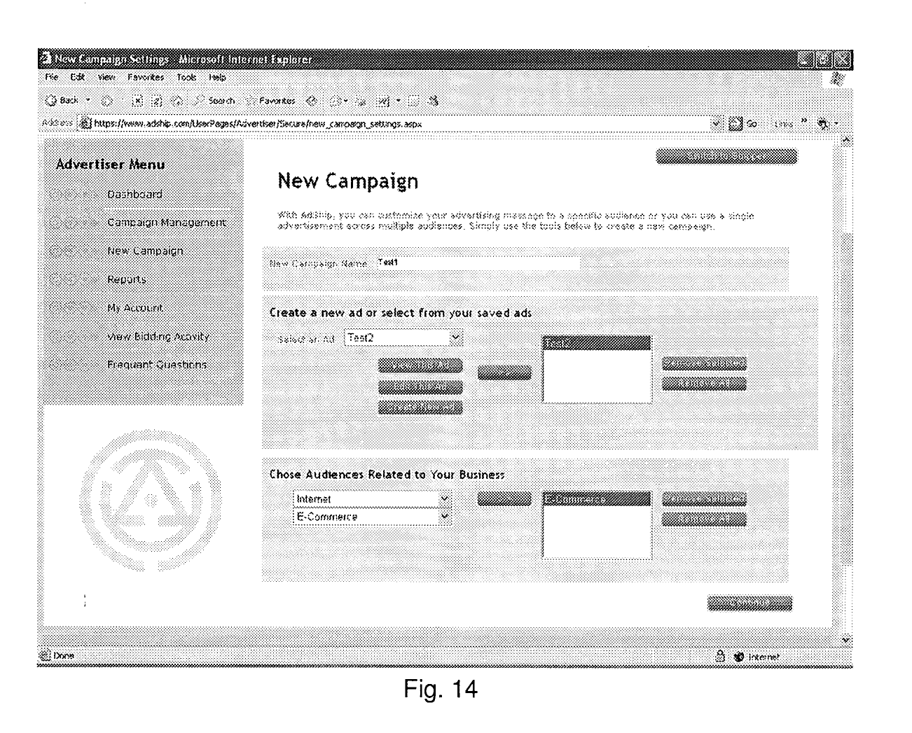

The user interface 550 also permits the advertiser 10 to create a new advertisement 522 for use in the campaign. As shown in FIG. 13, if the advertiser 10 decides to create a new advertisement 522, the user interface 550 permits the advertiser 10 to enter information related to this advertisement 522, such as the name of the advertisement 522, an ad copy image, as well as, for example, a headline, text, and a logo for the advertisement 522, as well as an advertisement website URL. Additionally, the user interface 550 may permit the advertiser to enter other information for the advertisement 522, such as a banner, a video, other images and so forth. Once the advertiser 10 has finished entering in all advertising data related to the advertisement 522, the user interface 550 may then permit the advertiser 10 to select the newly-created advertisement 522, as well as other advertisements 522, for the new advertising campaign, as indicated by FIG. 2D and FIG. 14.

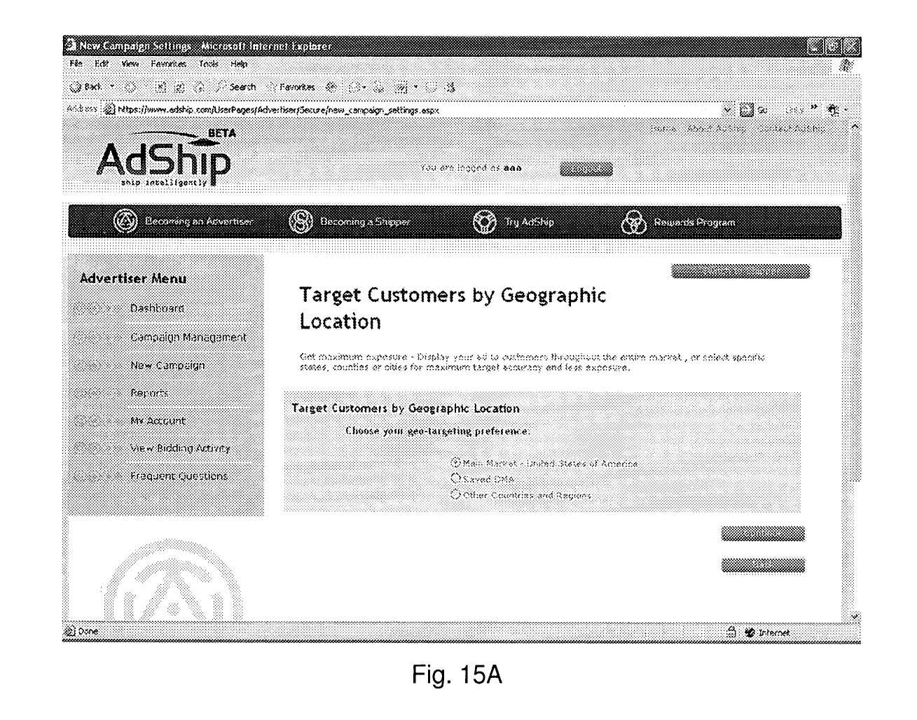

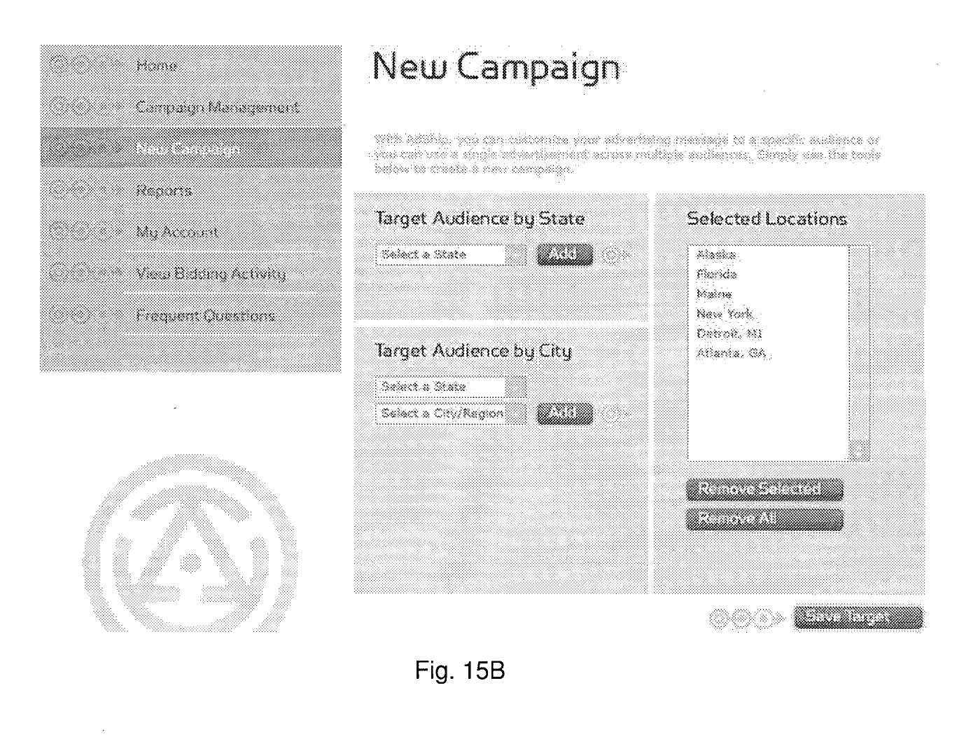

The user interface 550 also permits the advertiser 10 to enter demographic information for the new campaign, as shown in FIGS. 14 and 15. For example, the user interface 550 may permit the advertiser 10 to indicate the business or service classifications associated with the advertising campaign, the target geographic location of the advertising campaign (such as country, state, county or city), and any other suitable demographic information, which may then be used in conjunction with shipping information 510 to find a suitable shipper 30 for the advertising campaign, as previously described.

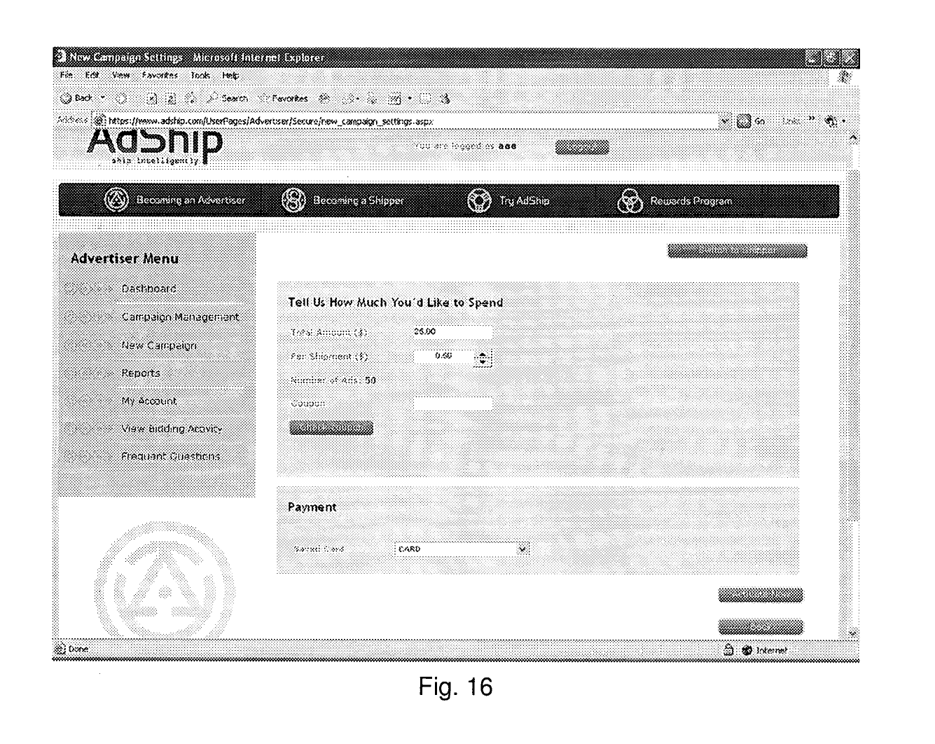

As shown in FIG. 16, the user interface 550 may also permit the advertiser 10 to indicate various advertising fees that the advertiser 10 is willing to pay for this advertising campaign. For example, the advertiser 10 may indicate the adverting fee that the advertiser 10 is willing to pay for each advertisement carried by a shipper 30; from this, the server 50 may compute the reward fee that would be paid to the shipper 30, as described earlier. Additionally, the advertiser 10 may indicate the maximum amount of advertising fees that the advertiser 10 is willing to pay for this advertising campaign, and select an account to be charged for this campaign. Once this maximum fee has been reached, the server 50 will no longer submit the related advertising information 520 to the shippers 30 for consideration, and thus no additional expenses will be incurred to the advertiser 10. However, the server 50 may implement a bidding system for advertisers 10. Hence, once the maximum fee for an advertising campaign 520 has been reached, the server 50 may select another advertising campaign 520 for use with a shipper 30. By way of example, the shipping information 510 may contain a reference to an advertising information 520 from which advertisements 522 are obtained, as well as advertising and reward fees. Once the maximum fee for the advertising information 520 has been exceeded, a new reference to another advertising information record 520 may be used in the shipping information 510 from which advertisements 522 may be obtained and advertising fees generated.

Once the advertiser 10 has finished inputting all data relevant to the advertising campaign, in various embodiments this advertising campaign information is then submitted for review by, for example, an administrator or the like of the server 50 to vet the new campaign for certain criteria. For example, the administrator of the server 50 may elect not to carry scandalous advertising material. If the advertising campaign as provided by the advertiser 10 is accepted, then the advertising information 520 for this campaign is entered into to the user database 54 as an active campaign, and thus eligible for consideration by shippers 30. If the advertising campaign is found to be unacceptable, then the user interface 550 may send a notification message to the advertiser 10 that the campaign has been denied, and, optionally, the reasons for such denial. Although the advertising information 520 related to this denied campaign may continue to exist in the user database 54, it is marked as ineligible and thus is not available for consideration by the shippers 30. The advertiser 10 may then seek to amended or edit the campaign 10, and thus the related advertising information 520.

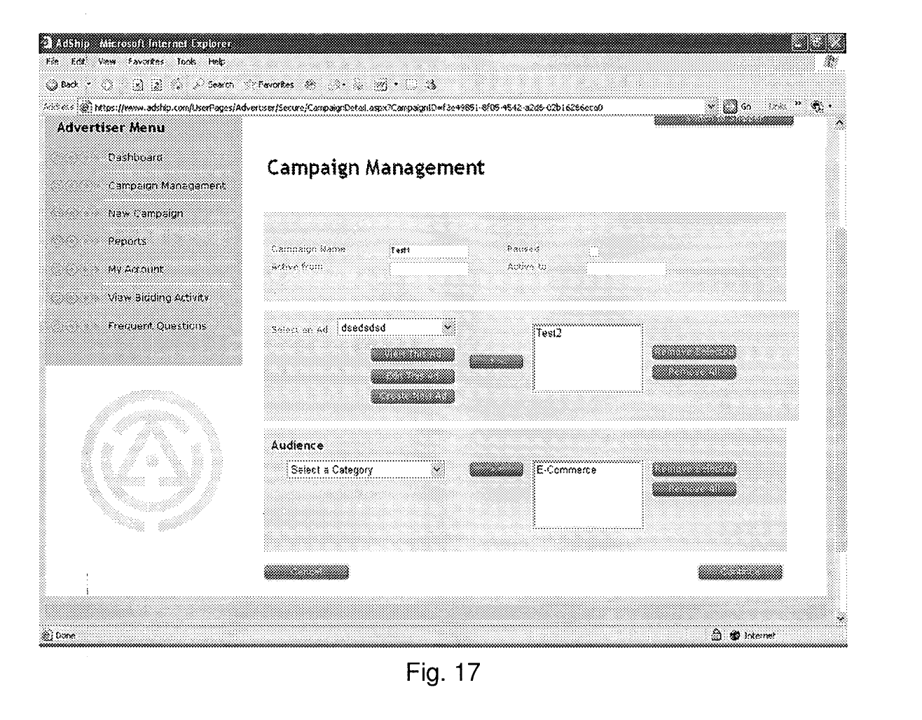

As shown in FIG. 17, the user interface 550 may further permit the advertiser 10 to edit pending advertising campaigns. For example, the advertiser 10 may elect to add or delete advertisements 522 from the campaign, to temporarily pause the campaign, in which case the related advertising information 520 is withdrawn from consideration from the shippers 30; and to change the dates within which the advertising campaign is active. Advertising campaigns that have expired or which are premature, as indicated by respective activation date ranges, do not have their corresponding advertising information 520 submitted to the shippers 30 for consideration.

FIGS. 5 through 17 illustrate aspects of the user interface 550 that may be provided by via an HTTP interface, as known in the art, to exchange information between the users 10, 30 and the server 50. However, such an interface need not be the exclusive interface for the user interface 550. Any suitable interface may be used. Indeed, preferred embodiments for the server 50 additionally employ Web Services within the user interface 550 that permit the users 10, 30 to exchange information directly with the server 50, rather than through a web page. All information that can be exchanged via, for example, web pages as shown in FIGS. 5 through 17, which require direct human input, may also be exchanged automatically in a direct computer-to-computer interaction via Web Services, as known in the art, which can be performed without human input. Exemplary Web Services functions, with their respective input parameters, error codes and results are presented in the following. Of course, other Web Service functions may be provided; the following list is simply illustrative in nature. Providing such Web Service routines, and other suitable routines to support the methodology described above, should be well within the means of one of ordinary skill in the art.

1. Get Quick Ship

This function may have as input parameters the user 10, 30 credentials. Errors may include access denied, and unknown user 10, 30. The results may include a list of objects representing options of a shipment (which were saved by server 50). This function may have various versions, each for a respective carrier 20, with each having a result specific to that carrier 20. These results can be used to create input objects used in, for example, obtaining rate information and creating new shipments.

2. Get Quote

This function may have as input parameters the user 10, 30 credentials, sender information, destination information, service and package details. Errors may include access denied, unknown user 10, 30; data not in dictionary; and get quote service errors. The results may include a list of service types and prices for a selected option. This function may have different versions for each respective carrier 20.

3. Verify Address

This function may verify an address using a carrier's 20 address verification service. As input, this function may take user 10, 30 credentials, and contact information. Errors may include access denied, unknown user 10, 30; address verification failed, data missing, invalid data, and data not in dictionary. The function may return true if verification succeeds.

4. Get Audiences

This function may be used by a shipper 30 obtain demographics options for a package. Input parameters may include user 30 credentials, and a user 30 audience filter marker. Errors may include access denied, and unknown user 10, 30. The results of this function may be, for example, in the form of a list of audience objects representing a tree of audiences defined by the server 50, or filtered to only a tree containing audiences selected in a user account at the server 50.

5. Get Regions

This function may be used to obtain regions recognizable by the server 50. Input parameters may include user 10, 30 credentials, and a parent region identifier. Errors may include access denied, and unknown user 10, 30. The results may include regions being children of the inputted region or countries if no parent region is defined.

6. Get Advertising Offers

This function may be used to obtain potential advertisers 10 for a package. Input parameters may include user 10, 30 credentials, the target audience, and the recipient 40 physical address. Errors may include access denied, unknown user 10, 30; address verification failed; data missing; invalid data; and data not in dictionary. Results may include a predetermined number, such as five, of the best advertising offers for a given target audience and recipient 40 address.

7. Rate Shipment

This function may be used to obtain rate information from the selected carrier 20 for a package. Input parameters may include user 10, 30 credentials; and a shipment data object. Errors may include access denied, unknown user 10, 30; address verification failed; data missing; invalid data; data not in dictionary; credit card verification failed; payment failed; and carrier 20 error. Results may include information about shipment costs, such as base charge, ad discount, server 50 discount, total surcharges, total charged. This function may have different versions for each respective carrier 20.

8. New Shipment

This function may be used to send a package. Input parameters may include user 10, 30 credentials; and a shipment data holding relevant shipping information 510. Errors may include access denied, unknown user, address verification failed, data missing, invalid data, data not in dictionary, advertiser not available, coupon invalid, credit card verification failed, payment failed, carrier 20 shipment error, and carrier 20 request error. Results may include shipment identifiers for shipment, an advertisement, and a label 24. This function may have different versions for each respective carrier 20.

9. Get Advertisement

This function may permit a user to obtain advertising information 510. Input parameters may include user credentials, an ad identifier, or a shipment identifier. Errors may include access denied, unknown user, image not found, and invalid data. The results may include, for example, advertisement image bytes.

10. Get Label

This function may permit a user to obtain a shipping label 24 from a selected carrier 20. Input parameters may include user credentials, and shipment identifier for shipping information 510. Errors may include access denied, unknown user, image not found, and invalid data. The result may include a shipping label 24 presented by way of image bytes.

11. Get COD Label

Input parameters may include user credentials, and a shipment identifier. Errors may include access denied, unknown user, image not found, and invalid data. Function results may include a shipment COD label 24 presented via image bytes.

12. Get Shipping History

This function may permit a user to view their shipping history. Input parameters may include user credentials, and a shipment search pattern. Errors may include access denied, unknown user, and invalid data. The results of this function may include a list of shipment history objects for a given criteria. The shipment history object may contain, for example, packaging and shipping details, payment information, recipient 40 information, and sender information.

13. Get Shipping Invoice

Input parameters may include user credentials, and a shipment identifier. Errors may include access denied, and unknown user. Results may include invoice data for a given shipment.

14. Track shipment

This function may permit a user 10, 30 to track a package. Input parameters may include user credentials, and a shipment identifier (such as the tracking number 28 and, optionally, an indicator of the carrier 20). Errors may include access denied, unknown user, and tracking error. Results may include delivered/undelivered status and, in case of delivered, the delivery date.

It will be appreciated that these and other possible Web Services functions, together with standard web pages, may together form a comprehensive user interface 550 that provides maximal flexibility for the users 10, 30. Using the user interface 550, the users 10, 30 may be able to track all of their packages across multiple carriers 20, as well as obtain their shipping histories for multiple carriers 20. In short, the server 50 may present a one-stop solution for users 10, 30 to interface with multiple carriers 20, in addition to offering shippers 30 discounted shipping rates in exchange for carrying advertisements.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the following claims.

What is claimed is:

1. A method for shipping a package comprising:
accepting shipping information from at least a shipper wanting to ship a package;
accepting advertising information from at least an advertiser;
utilizing at least a portion of the shipping information to obtain a shipping label and a tracking number from a carrier;
providing to the shipper the shipping label and at least an advertisement obtained from first advertising information obtained from a first advertiser; and
sending a first notification message to a recipient of the package, the first notification message comprising shipping status information for the package and an advertisement obtained from the first advertising information.

2. The method of claim 1 further comprising:
utilizing the tracking number to obtain tracking information from the carrier; and
sending a second notification message to the recipient comprising shipping status information obtained at least in part from the tracking information, and further comprising an advertisement obtained from the first advertising information.

3. The method of claim 1 further comprising:
utilizing the tracking number to obtain tracking information from the carrier; and
sending a second notification message to the recipient comprising shipping status information obtained at least in part from the tracking information, and further comprising an advertisement obtained from second advertising information of a second advertiser that is not the same as the first advertiser.

4. The method of claim 1 further comprising in response to receiving a request from the recipient, sending a second notification message to the recipient, the second notification message comprising shipping status information and an advertisement obtained from the first advertising information.

5. The method of claim 4 wherein the first and second notification messages are each selected from the set consisting of a facsimile transmission, an email message, a web page, a cell phone message (SMS message), a message carried by an instant messaging service, and a telephonic message.

6. The method of claim 5 wherein the second notification message is a web page and the first notification message is an email.

7. The method of claim 1 further comprising instructing the shipper to print out the advertisement provided to the shipper and place the advertisement inside the package.

8. The method of claim 1 further comprising:
utilizing demographic information contained in the shipping information and in the first advertising information to select the first advertising information from a plurality of advertising information records.

9. The method of claim 1 further comprising providing one or more of a reward fee and a shipping rate discount to the shipper, the one or more of the reward fee and the shipping rate discount obtained from an advertising fee in the first advertising information.

10. A system for providing shipping and advertising services, the system comprising:
at least a processor;
memory in communications with the processor, the memory comprising program code executable by the processor to perform the following steps:
accepting shipping information from at least a shipper wanting to ship a package;
accepting advertising information from at least an advertiser;
utilizing at least a portion of the shipping information to obtain a shipping label and a tracking number from a carrier;
providing to the shipper the shipping label and at least an advertisement obtained from first advertising information obtained from a first advertiser; and
sending a first notification message to a recipient of the package, the first notification message comprising shipping status information for the package and an advertisement obtained from the first advertising information;
a database for storing the shipping information and the advertising information.

11. The system of claim 10 wherein the program code further performs the following steps:
utilizing the tracking number to obtain tracking information from the carrier; and
sending a second notification message to the recipient comprising shipping status information obtained at least in part from the tracking information, and further comprising an advertisement obtained from the first advertising information.

12. The system of claim 10 wherein the program code further performs the following steps:
utilizing the tracking number to obtain tracking information from the carrier; and
sending a second notification message to the recipient comprising shipping status information obtained at least in part from the tracking information, and further comprising an advertisement obtained from second advertising information of a second advertiser that is not the same as the first advertiser.

13. The system of claim 10 wherein the program code further performs the following step:
in response to receiving a request from the recipient, sending a second notification message to the recipient, the second notification message comprising shipping status information and an advertisement obtained from the first advertising information.

14. The system of claim 13 wherein the first and second notification messages are each selected from the set consisting of a facsimile transmission, an email message, a web page, a cell phone message (SMS message), a message carried by an instant messaging service, and a telephonic message.

15. The system of claim 14 wherein the second notification message is a web page and the first notification message is an email.

16. The system of claim 10 wherein the program code further performs the following step:
instructing the shipper to print out the advertisement provided to the shipper and place the advertisement inside the package.

17. The system of claim 10 wherein the program code further performs the following step:
utilizing demographic information contained in the shipping information and in the first advertising information to select the first advertising information from a plurality of advertising information records stored in the database.

18. The system of claim 10 wherein the program code further performs the following step:
computing one or more of a reward fee and a shipping rate discount for the shipper, the one or more of the reward fee and the shipping rate discount obtained from an advertising fee in the first advertising information.
